(19) United States
(12) Patent Application Publication
(10) Pub. No.: US 2003/0188180 A1
(43) Pub. Date: Oct. 2, 2003

(54) Secure file verification station for ensuring data integrity

(76) Inventor: Gregor T. Overney, Sunnyvale, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/112,473

(22) Filed: Mar. 28, 2002

(51) Int. Cl. H04L 9/00

(52) U.S. Cl. 713/193

(57) ABSTRACT

A secure file verification station receives and stores a data file received from a trusted source. The verification station applies a hashing function to the data file, and then encrypts the hash using a unique symmetric encryption key derived from a seed value that is maintained securely within the verification station. The encrypted hash is then appended to the data file. The station is networked to client workstations to which it delivers data files. To verify the integrity of a data file it has received from the verification station, a client workstation sends back the data file to the station, where the encrypted hash is decrypted using the unique symmetric key that is again generated from the seed value. A recomputed hash of the data is compared to the decrypted hash value. If the two hash values are equal, the integrity of the data is verified; otherwise the file has been modified in some way. The verification station sends a message to the client workstation indicating whether or not the integrity of the data file has been verified.

### FIELD OF THE INVENTION

The present invention relates to data communication security, and more particularly relates to ensuring the integrity of communicated data using a secure file verification station.

### BACKGROUND INFORMATION

Data integrity is a vital requirement for secure and accurate data communication. The determination of whether a data file has “data integrity” means the ability to detect whether any alteration of the contents of a data file has taken place after a trusted source has parted with the original file. In the field of mass spectrometry, new instrumental systems include a data acquisition and analysis component which can be connected to a network, so that remote clients can gain access to the data obtained and analyzed by the instrumental system. Since the precise data obtained by the instrumental system can be proprietary and valuable, it is accordingly important to safeguard the privacy and integrity of this data.

In conventional file verification techniques, a data source generates both a private encryption key and a public decryption key, and supplies the public key (and the associated encryption/decryption scheme) to clients. These techniques are referred to as asymmetric because the private encryption key used at the data source is not necessarily equivalent to the public encryption key used by the client. Moreover, to ensure security, the private key is not derivable from the public key. Commonly used encryption schemes that use asymmetric keys in this context include DH, RSA/MD5, MQV, and ElCamal, for which public information is publicly available, e.g., MQV and ElCamal are described in IEEE P1363. In the conventional techniques, a data source receives a data file and typically computes a hash of the data. The data source then encrypts the hash of the data using the private key, and delivers the encrypted data to clients. Clients can then use the public key to decrypt the hash using the transmitted decryption algorithm. After decryption, the client can determine data integrity by recomputing a hash value for the data and comparing it to the hash value calculated at the data source. Equal hash values imply that the data has not been tampered with.

One of the disadvantages of the conventional asymmetric private/public key techniques is that they expose the public key, the decryption algorithm and the hash function. For example, clients receiving data over the Internet may download a Java applet that contains all of this information. Although the client to which the applet is directly sent may be trusted, if a non-trusted entity is somehow able to access the applet, for example, by monitoring communications in the network, it could run all the Java byte-code in a specially modified Java Virtual Machine (JVM). This modified JVM could allow the non-trusted client to modify the decryption algorithm and tamper with the data file, thus compromising data integrity. Another disadvantage of conventional asymmetric encryption is that the standard public/private key algorithms often have reduced encryption strength in comparison to certain encryption techniques that employ symmetric keys and therefore must employ larger keys to compensate for the reduced strength. The larger keys require a longer time to process and slow the encryption and decryption operations.

Therefore, for applications in which data integrity cannot be compromised, what is needed is an apparatus and method for providing data to clients that does not expose encryption keys and/or encryption algorithms in an insecure manner and does not suffer from the reduction in encryption strength associated with conventional asymmetric private/public encryption techniques.

### SUMMARY OF THE INVENTION

The present invention provides a secure file verification station for verifying the data integrity of a data file. According to an embodiment of the invention, the secure file verification station includes a secure memory unit for receiving the data file from a trusted source and for securely storing the data file, and a processor coupled to the secure memory unit configured to generate a unique encryption key for the data file, to apply hashing functions to the data file and to apply encryption and decryption functions that use the unique encryption key derived from the data file. The secure file verification station also includes a network interface for transmitting the data file and encrypted data derived from the data file over a network to one or more clients and for receiving the data file from one or more clients subsequently. Upon receipt of the data file from the one or more clients, the processor verifies data integrity of the received data file. According to this embodiment, the secure verification station does not expose the unique encryption key, or the hashing and encryption/decryption functions to the one or more clients.

According to an embodiment of the invention, the encryption and decryption functions applied by the processor are based on elliptic curves.

The present invention also provides a mass spectrometry instrumental system that is coupled to one or more client workstations over a network. This instrumental system includes: an analyte ion source; a mass spectrometer for receiving analyte ions from the analyte ion source and selecting specific ions among the analyte ions for transmission; and an ion detector for detecting the selected ions and transmitting an electrical signal in response to detection. The instrumental system also includes a data acquisition and analysis unit for receiving signals transmitted by the ion detector, analyzing the received signals, and producing data files containing results of analysis and identification information, and a secure file verification station coupled to the data acquisition and analysis unit and to the one or more clients over the network. The secure file verification station transmits data files to the one or more clients and verifies the integrity of the data files received from the one ore more clients.

The present invention also provides a method of verifying the data integrity of a data file having a content portion and a header portion at a secure file verification station at which a seed value is securely stored. According to an embodiment of the invention, the method includes encrypting data from the data file using a unique symmetric key derived in part from the seed value, and then transmitting the data file with the encrypted data to at least one client workstation. Upon receiving a request for verification, the data file is received back from the at least one client workstation. The encrypted data from the data file is decrypted, and the data integrity of the data file is verified based on the decrypted data and the content portion of the received data file.

According to an embodiment of the method of the present invention, the content portion of the data file is hashed using a hashing function to generate a first hash key. According to one particular implementation, the first hash key is 160 bits in length.

According to a further embodiment, a unique symmetric encryption key is generated for the data file based on the seed value and information in the header portion of the data file, which unique symmetric key is not stored on any non-volatile storage medium.

According to a further embodiment, the seed value is synchronized with information in the header portion of the data file using XOR combination.

According to a further embodiment, a hash key is encrypted using the unique symmetric key and then appended the to the data file.

According to a further embodiment, the method of the present invention includes mapping the first hash key onto a second hash key approximately 2.5 times longer than the first hash key, encrypting the second hash key using the unique symmetric key, and appending the second hash key to the data file.

According to a further embodiment, the second hash key is encrypted using an encryption function based on elliptic curves.

According to a further embodiment, the first hash key is mapped onto the second hash key using XOR combination.

According to a further embodiment, after receiving the data file back from the at least one client workstation, the unique symmetric key is regenerated based on the seed value and information in the header portion of the data file.

According to a further embodiment, a new hash key is generated from the content portion of the received data file.

According to a further embodiment, the method of the present invention includes decrypting the encrypted hash key appended to the data file to recover an original hash key, comparing the original hash key with the new hash key, and determining the data integrity of the data file. Data integrity is verified when the original hash key is equal to the new hash key, and it is not verified when the original hash key is not equal to the new hash key.

According to a further embodiment, a message is sent to the at least one client workstation indicating whether data integrity of the data file has been verified.

### BRIEF DESCRIPTION OF THE DRAWINGS

FIG. 1 shows an exemplary mass spectrometer instrumental system with integrated data acquisition and analysis capability incorporating the secure file verification station according to an embodiment of the present invention.

FIG. 2 is a schematic illustration of a process for encrypting a data file used by the secure file verification station according to an embodiment of the present invention.

FIG. 3 is a schematic illustration of a method for verifying the integrity of a data file using the secure file verification station according to an embodiment of the present invention.

### DETAILED DESCRIPTION

In accordance with the present invention, a secure file verification station receives and stores one or more data files received from a data source. The verification station applies a hashing function to the data files, and then encrypts the hash using a symmetric encryption key derived from a seed value that is maintained securely within the file verification station. The encrypted hash is then appended to the data file. The station is networked to local or remote workstations and can deliver data files to the workstations that have authenticated themselves appropriately. In order for a workstation to verify a data file it has received from the secure file verification station, the workstation sends back the data file to the station, where the data is decrypted using the symmetric key that is again generated from the seed value. A recomputed hash of the data can be compared to the decrypted hash value. If the two hash values are equal, the integrity of the data is verified, and the verification station sends that workstation a signal that file has passed the verification process indicating that the data file has not been modified. If the hash values are unequal, the verification station sends a corresponding signal indicating that the integrity of the data file has not been verified. In all events, the verification process is performed and controlled solely by the secure file verification station.

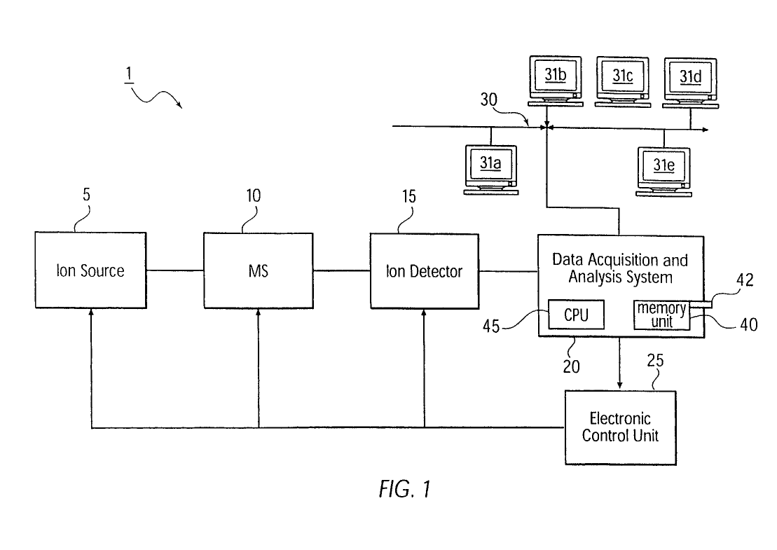

FIG. 1 depicts an exemplary mass spectrometer instrumental system with integrated data acquisition and analysis capability incorporating the secure file verification station according to an embodiment of the present invention. It is noted at the outset that while the secure file verification station is described in the context of a mass spectrometer instrumental system, the secure file verification station according to the present invention can be applied in any context where it is desired to provide data security and integrity without publicly exposing the relevant encryption/decryption keys and/or algorithms.

In the mass spectrometer instrumental system 1, an ion source 5 provides a sample of analyte ions to a mass spectrometer 10 which selects ions for transmission that have a mass-to-charge ratio within a certain range controllable by the operator of the mass spectrometer. The mass spectrometer 10 includes one or more vacuum chambers, ion optics and mass analyzer sections arranged to transmit the selected ions to an ion detector 15. The ion detector 15 may be a charge coupled device, for example, that generates current or voltage signals when analyte ions come into contact with its surface. The amplitudes of the signals generated by the ion detector 15 are proportional to the number of ions detected. An electronic control unit 25 is used to control the functions and operational parameters of the ion source 5, the mass spectrometer 10, and the ion detector 15.

Signals generated at the ion detector 15 are delivered to a data acquisition and analysis system 20 (“DAS”), such as a proprietary embedded controller, where the data is stored in files and optionally formatted into a descriptive form such as a spectrum graph illustrating the detected current (and hence, the number of detected ions) at specific mass-to-charge ratio levels. The data acquisition system 20 is coupled to a local or wide area network 30, through which client workstations 31a, 31b, 31c, 31d, 31e can obtain information stored in the DAS 20, such as, for example, experimental data indicating the chemical components of an analyzed sample. The client workstations are permitted access to the DAS 20 only after authentication by password. All communications of passwords to the client are encrypted using a public key encryption scheme such as DH, MQV, or ElCamal.

As noted above, it is important in the context of this mass spectrometer instrument system 1 to guarantee the integrity of the data delivered to the workstations 31a, 31b, 31c, 31d, 31e without compromising the security of encryption schemes used to protect the data. With this end in mind, the DAS 20 includes firmware programmed to perform hashing, encryption, and decryption operations (described more fully below) and thus, according to one embodiment, the DAS can serve as a secure file verification station. The firmware may include an embedded CPU 45 for performing calculations and a memory unit 40 for storing relevant key information and data. The memory unit 40 includes both volatile and non-volatile storage components. The non-volatile storage components of the memory unit 40 can be implemented as a FLASH memory module or as a separate hard drive. As will be described further below, the DAS 20 may provide a secure serial-connection 42 accessible by a mechanical key device, for example, through which authorized personnel can change pre-configured key values stored in memory unit 40. In this embodiment of the secure file verification station, the DAS 20 is co-located with the mass spectrometer apparatus and maybe embedded securely within the apparatus. According to another embodiment, a dedicated server (not shown) independent of the mass spectrometer DAS 20 can serve as the secure file verification station. In this case, the dedicated server would communicate with the DAS 20 to receive data files and would be coupled to the client workstations over the network 30 instead of the DAS. The dedicated server would of course also be maintained at a physically secure location.

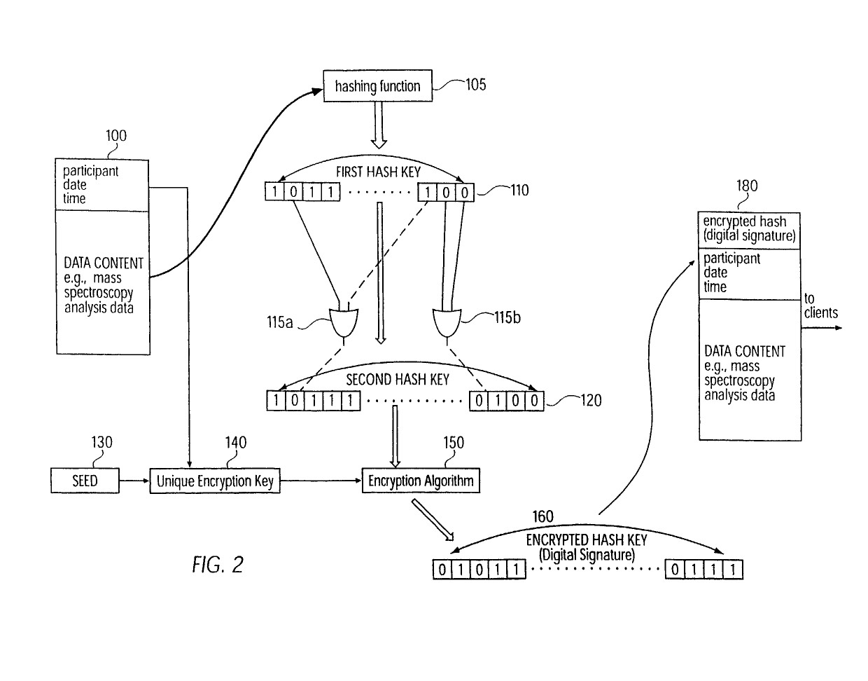

FIG. 2 is a schematic illustration of a method for encrypting a data file used by the secure file verification station according to an embodiment of the present invention. According to this method, the secure file verification station receives a data file 100 containing a header portion and a content portion. According to one implementation, the data file 100 may contain data obtained from the DAS 20 of the mass spectrometer instrumental system 1. In this case, the data content portion of the file 100 may include spectral information for an analyte sample, while the header portion may include information such as the date and time at which sample analysis took place, the participant or operator who conducted the analysis, and other identification information useful for characterizing the data file. This data file is then stored at the memory unit 40 of the secure file verification station.

The embedded CPU 45 accesses the data file 100 and generates a first hash key 110 from the data file using a hashing function 105. According to a given implementation, the first hash key 110 may be 160 bits in length and the hashing function 105 may be SHA-1 (Secure Hashing Algorithm, published by the U.S. government in publication FIPS-PUB 180-1). In more general terms, a hashing function is a one-way cryptographic function that is computed over the length of the data file being secured. The hash is one-way in that there is no reverse or inverse function to the hashing function that can undo the operation of the hashing function. The hashing function generates a “digest” that is unique to the data file, such that no two different data files can realistically produce the same digest. If even a single byte of a data file is changed, the resulting digest produced from the modified file will not be equivalent to the digest produced from the original, making the hash function a reliable means to verify data integrity.

Using a protected function that employs a combination of XOR operations (depicted schematically as two XOR gates 115a, 115b for purposes of illustration), the first hash key 110 is mapped onto a larger bit sequence, the second hash key 120, that is approximately 2.5 longer than the first hash key. Accordingly, when the first hash key 110 is implemented as a 160 bit sequence, the second hash key 120 may contain 416 bits.

The embedded CPU 45 also simultaneously generates a symmetric key 140 used for encryption. The symmetric key 140 is produced by synchronizing a protected seed value 130 with data and time information (and/or other information) taken from the header of the data file. The seed value is a large constant, e.g., a 1024 bit sequence, which is securely stored in the memory unit 40. The only way to alter the seed value is by way of the secure serial connection 42 accessible only with a physical mechanism held by authorized personnel. It is emphasized that the seed value 130 never leaves the secure file verification station and its security is continually maintained. By synchronizing the seed value with information particular to the data file 100, the resulting symmetric key 140 is unique to the specific data file. Synchronization is accomplished by supplying bits of the seed value 130 and the header file through a sequence of XOR gates, effectively stamping the seed value with the header information in a pseudo-random manner. Synchronization provides another level of security because it ensures that the actual key used for encryption/decryption is never written to non-volatile storage such as FLASH RAM.

Once both the second hash key 120 and the symmetric key 140 are generated, the second hash key 120 is encrypted using an encryption function 150 that employs the symmetric key 140 in the encryption process to generate a digital signature. According to one implementation, the encryption function is based on elliptic functions, although other schemes can be used in the context of the present invention. Encryption based on elliptic functions is described in “Elliptic Curves in Cryptography” by Ian Blake et al., Cambridge University Press, 2000, for example. One class of elliptic curves consists of elements (x,y) that satisfy an equation of the form y²+xy=x³+a₁x²+a₂ with a₂≠0. Elliptic curves can be defined over any field such as real, fractional, and complex numbers. In encryption schemes, elliptic curves are typically defined over finite fields, such as the set of integers modulo a prime number n. The size of n determines the level of security, and is typically chosen to be in the range of 100 to 400 bits. A finite field consists of a finite set of elements together with two operations, addition and multiplication, that satisfy certain arithmetic properties. One of the properties of an elliptic curve defined over a finite field is that if point A and point B are both points on an elliptic curve, then A+B will also be a point on the curve.

Elliptic curves are useful for encryption because of the extreme difficulty in solving what is known as the elliptic curve discrete logarithm problem (ECDLP) which is briefly stated as follows. Given some prime number p, an elliptic curve defined modulo p, and xP, which represents the point P on the elliptic curve added to itself x times, if Q is a multiple of P such that Q=xP, then the ECDLP is to determine x given P and Q. The general conclusion of those skilled in the art is that the ECDLP requires fully exponential time to solve. The problem is so difficult that an elliptical curve cryptosystem implemented over a 160-bit field currently offers substantially the same security as a 1024-bit RSA modulus. To give an another indication of the encryption strength of elliptic curves, the security level of a 300-bit key is equal to 10²⁰ MIPS years. In other words, it is estimated that it would take 10²⁰ processors computing 1 million instructions per second continuously for one year to crack the key.

In one encryption process that employs the properties of elliptic curves, the CPU 45 defines an elliptic curve E over a finite field, the number of points in E being divisible by a large prime number n. A point P on the curve E is selected by the CPU and then a random integer less than n (denoted k) and a new point (=kP or (x₁,y₁)) is computed. The CPU 45 also computes further quantities r=x₁ mod n and k⁻¹ mod n. At this point the second hash key 120 and the symmetric key 140 are applied and a quantity G=k⁻¹(second hash key+symmetric key times r) mod n is computed. By computing a quantity that depends on the value of the second hash key 120 and the symmetric key 140 but also includes random variables based on elliptic curves (k and P), the second hash key 120 is thereby encrypted. The resulting encrypted hash key 160 is then appended to the end of the data file 100, thus generating a lengthened data file 180. Data file 180 is then transferred to client workstations over secure or insecure lines.

The additional encryption of the hash key provides additional protection against modification of the data files. Any entity that seeks to modify the files must not only apply the same hashing function, but also must be able to obtain the symmetric key to decrypt the hash value. Another advantage of encrypting the hash key is that such encryption can avoid certain legally mandated restrictions on export of encryption technology imposed by the U.S. government because the hash key does not contain additional information. However, where such restrictions apply, lower-level encryption can be employed to comply with such restrictions.

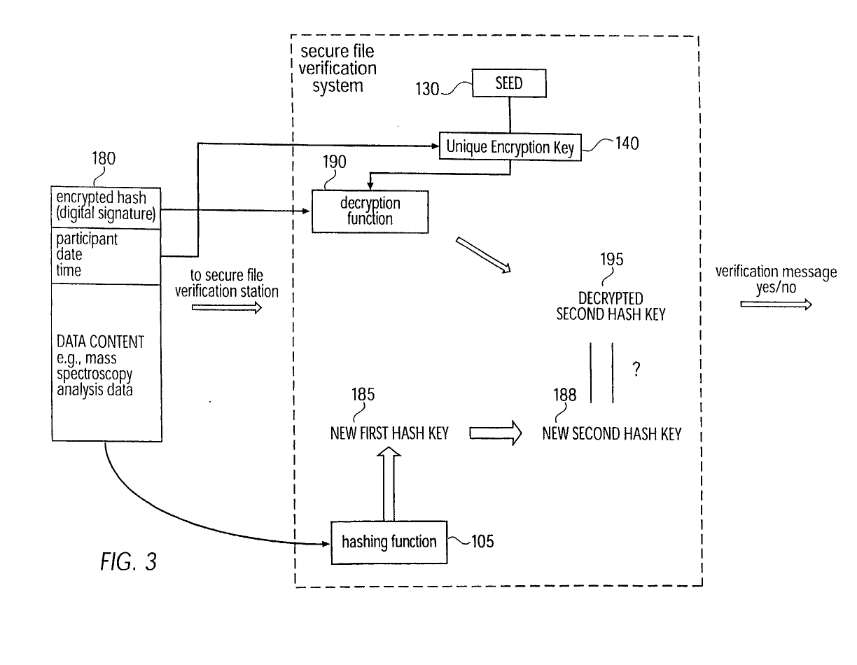

FIG. 3 is a schematic illustration of a method for verifying the integrity of a data file using the secure file verification station according to an embodiment of the present invention. If a client desires to verify the integrity of a received data file, the file is sent back to the secure file verification station for verification. At the station, two independent processes occur. In the first process, the same hashing function applied during the encryption process is applied to the data content portion of the data file 180 to create a new first hash key 185. A new second hash key 188 is generated by the same XOR combination method described above. Thus, if the data content of the data file 180 has not changed from when it was originally generated at the secure file verification station, then the second hash key should be the same as the original second hash key.

To verify this, the original second hash key is extracted from the encrypted hash key 160 that was appended to the original file. Thus, in the second process, the encrypted hash key 160 is decrypted using a decryption function 190 that is an inverse of the encryption function. Since the key used for encryption is symmetric, the original symmetric key 140 is also used in the decryption process. The symmetric key is similarly regenerated 140 from the seed value 130 and the header portion of the data file 180. Through this process, a decrypted hash key 195 is computed. To verify the integrity of the data file 180, the decrypted hash key 195 is compared to the new second hash key 188. If it is determined that these two quantities are equal, the integrity of the file is verified, and if they are not equal, then it is concluded that the file has been modified in some way from its original state. The secure file verification station sends a message to the clients indicating the outcome of this determination, as a simple yes or no message, for example, where yes indicates that the integrity of the file has been verified and no indicates the opposite determination.

In the foregoing description, the invention has been described with reference to a number of examples that are not to be considered limiting. Rather, it is to be understood and expected that variations in the principles of the file verification station, mass spectrometer instrumental system, and verification methods herein disclosed may be made by one skilled in the art and it is intended that such modifications, changes, and/or substitutions are to be included within the scope of the present invention as set forth in the appended claims.

What is claimed is:

1. A secure file verification station for verifying data integrity of a data file comprising:
a secure memory unit for receiving the data file from a trusted source and for securely storing the data file;
a processor coupled to the secure memory unit configured to generate a unique encryption key for the data file, to apply hashing functions to the data file and to apply encryption and decryption functions that use the unique encryption key derived from the data file; and
a network interface for transmitting the data file and encrypted data derived from the data file over a network to at least one client and for receiving the data file from the at least one client subsequently,
wherein the processor verifies data integrity of the data file subsequently received from the at least one client.

2. The secure file verification station of claim 1, wherein the encryption key is a symmetric key.

3. The secure file verification station of claim 2, wherein the encryption and decryption functions are based on elliptical curves.

4. The secure file verification station of claim 1, wherein the secure memory unit stores a seed value for generating the encryption key for the data file, and the processor generates a unique symmetric key for the data file based on the seed value and information specific to the data file.

5. The secure file verification station of claim 4, wherein the seed value is 1024 bits in length.

6. The secure file verification station of claim 4, further comprising:
a secure serial connection coupled to the secure memory unit operable by a secure mechanism through which an authorized operator can modify the seed value stored in the secure memory unit.

7. The secure file verification station of claim 1, wherein the processor generates a message for transmission to the at least one client over the network indicating whether the data integrity of the data file has been verified.

8. The secure file verification station of claim 7, wherein the processor computes an encrypted hash digest and appends the encrypted hash digest to the data file before the data file is transmitted to the at least one client.

9. The secure file verification station of claim 8, wherein the processor verifies data integrity of the data file by decrypting the encrypted hash digest appended to the data file and comparing a new hash digest for the data file with the decrypted hash digest derived from the received file.

10. A mass spectrometry instrumental system coupled to at least one client workstation over a network comprising:
an analyte ion source;
a mass spectrometer for receiving analyte ions from the analyte ion source and selecting specific ions among the analyte ions for transmission;
an ion detector for detecting the selected ions and transmitting an electrical signal in response to detection;
a data acquisition and analysis unit for receiving signals transmitted by the ion detector, analyzing the received signals, and producing data files containing results of analysis and identification information; and
a secure file verification station coupled to the data acquisition and analysis unit and to the at least one client over the network for transmitting data files to the at least one client and for verifying integrity of data files received from the at least one client.

11. The mass spectrometry instrumental system of claim 10, wherein the secure file verification station is situated within the data acquisition and analysis unit and includes:
a secure memory unit for receiving the data file from the data acquisition and analysis unit and for securely storing the data file; and
a processor coupled to the secure memory unit configured to generate a unique encryption key for the data file, to apply hashing functions to the data file and to apply encryption and decryption functions that use the unique encryption key derived from the data file.

12. The mass spectrometry instrumental system of claim 10, wherein the secure file verification system is a securely maintained dedicated server remotely located from the data acquisition and analysis system.

13. The mass spectrometry instrumental system of claim 11, wherein the secure memory unit stores a seed value for generating the encryption key for the data file, and the processor generates a unique symmetric key for the data file based on the seed value and the identification information in the data file.

14. The mass spectrometry instrumental system of claim 13, wherein the encryption and decryption functions are based on elliptic curves.

15. The mass spectrometry instrumental system of claim 14, wherein the processor computes an encrypted hash digest, appends the encrypted hash digest to the data file before the data file is transmitted to the at least one client, and verifies data integrity of the data file by decrypting the encrypted digest and comparing a new hash digest computed for the data file with the decrypted hash digest derived from the received file.

16. A method of verifying data integrity of a data file having a content portion and a header portion at a secure file verification station at which a seed value is securely stored, the method comprising:
encrypting data from the data file using a unique symmetric key derived in part from the seed value;
transmitting the data file with the encrypted data to at least one client workstation;
upon a verification request, receiving the data file back from the at least one client workstation;
decrypting the encrypted data from the data file; and
verifying data integrity of the data file based on the decrypted data and the content portion of the received data file.

17. The method of claim 16, further comprising:
hashing the content portion of the data file to generate a first hash key.

18. The method of claim 17, wherein the first hash key is 160 bits in length.

19. The method of claim 17, further comprising:
generating a unique symmetric encryption key for the data file based on the seed value and information in the header portion of the data file,
wherein the unique symmetric key is not stored on any non-volatile storage medium.

20. The method of claim 19, further comprising:
synchronizing the seed value with information in the header portion of the data file using XOR combination.

21. The method of claim 17, further comprising:
encrypting a hash key using the unique symmetric key; and
appending the encrypted hash key to the data file.

22. The method of claim 21, further comprising:
mapping the first hash key onto a second hash key approximately 2.5 times longer than the first hash key;
encrypting the second hash key using the unique symmetric key; and
appending the second hash key to the data file.

23. The method of claim 22, further comprising:
encrypting the second hash key using an encryption function based on elliptic curves.

24. The method of claim 22, wherein the first hash key is mapped onto the second hash key using XOR combination.

25. The method of claim 21, further comprising:
after receiving the data file back from the at least one client workstation, regenerating the unique symmetric key based on the seed value and information in the header portion of the data file.

26. The method of claim 25, further comprising:
generating a new hash key from the content portion of the received data file.

27. The method of claim 26, further comprising:
decrypting the encrypted hash key appended to the data file to recover an original hash key; and
comparing the original hash key with the new hash key;
determining that data integrity is verified when the original hash key is equal to the new hash key, and making an opposite determination when the original hash key is not equal to the new hash key.

28. The method of claim 27, further comprising:
sending a message to the at least one client workstation indicating whether data integrity of the data file has been verified.
